(19) United States
(12) Patent Application Publication
(10) Pub. No.: US 2021/0329064 A1
(43) Pub. Date: Oct. 21, 2021

(54) Parametric Parsing Based Routing System in Content Delivery Networks

(71) Applicant: Medianova Internet Hizmetleri Ve Ticaret Anonim Sirketi, Sisli/Istanbul (TR)

(72) Inventors: Serkan SEVIM, Istanbul (TR); Tugce BILEN, Istanbul (TR); Berk CANBERK, Istanbul (TR)

(73) Assignee: Medianova Internet Hizmetleri Ve Ticaret Anonim Sirketi, Sisli/Istanbul (TR)

(21) Appl. No.: 17/273,018

(22) PCT Filed: Nov. 6, 2018
(86) PCT No.: PCT/TR2018/050660

§ 371 Date: Mar. 3, 2021

(30) Foreign Application Priority Data
Sep. 5, 2018 (TR) TR2018/12690

(51) Int. Cl. H04L 29/08

(52) U.S. Cl. CPC H04L 67/1008; H04L 67/10; H04L 67/2842

(57) ABSTRACT

Parametric Parsing Based Routing System In Content Delivery Networks The invention enables CDN (Content Delivery Networks) companies to provide higher quality service by minimizing user delays and losses during request routing procedures. CDN is based on the principle that users can access the content as soon as possible by obtaining the data requested by the users via PoPs (Point of Presences) located at different points in the world.

### TECHNICAL FIELD

The invention enables CDN (Content Delivery Networks) companies to provide higher quality service by minimizing user delays and losses during request routing procedures. CDN is based on the principle that users can access the content as soon as possible by obtaining the data requested by the users via PoPs (Point of Presences) located at different points in the world.

### PRIOR ART

The request routing procedure in the content delivery networks enables the user requests to be transmitted to the nearest PoP, which at the same time ensures a load balancing between the PoPs. There are different request routing procedures defined as static and dynamic in the literature. Dynamic algorithms gather information about the network status and this information is used for routing. Static algorithms, on the other hand, do not use any information gathering mechanism. As a static algorithm, user requests are distributed to PoPs with one possibility. In another algorithm, an equal number of user requests are forwarded statically to all PoPs. In addition, user requests can be dynamically transferred according to the load in the PoPs or it is possible to make a selection between two POPs with a minimum load. PoPs can be selected according to the selected parameters such as available bandwidth and request routing can be ensured. However, the algorithms mentioned and found in the literature do not examine the large size user requests and their effects on the PoPs and users. The table in FIG. 3 shows the request routing mechanism called Partial Site, where user requests are met from the nearest PoP.

Systems using the current art contains following process steps:
Creation of a request for the web page requested by the user (S1001),
Delivery of the content to the user by the main server (S1002)
Delivery of customer content requests to PoP's according to the request forwarding procedure (S1003)
Ensuring the delivery of content from the most appropriate PoP to the user (S1004).

As mentioned above, the content delivery networks used today ensure that user requests are delivered to and satisfied from the nearest PoP. Therefore, sudden and excessive overloading occurs in the nearest PoPs. As a result, user losses and response times are prolonged. In today's content delivery networks, elements such as controllers, load detection modules, mapping, host server modeling, queuing, parsing, PoP modeling, adjustment, content distribution module, and content consolidation modules are not used.

Purpose of the Invention

The purpose of the invention is to enable CDN (Content Delivery Networks) companies to provide higher quality service by minimizing user delays and losses during request routing procedures.

Another purpose of the invention is to prevent sudden and over loading of PoPs, thereby reduce user losses and response times.

Another purpose of the invention is to provide an autonomous way to consolidate large size user requests in the main server and again to transfer to the PoP.

Another purpose of the invention is to ensure that the user requests delivered are transferred to more than one PoP in order to access the contents of large sizes, thereby avoiding the problem of sudden and excessive loading of a single PoP.

The parametrical-parsing method developed to realize the aforementioned objectives is composed of a main server (1), a controller (2), a load detection module (3), mapping (4), main server modeling (5), queuing (6), parsing (7), PoP modeling (8), adjustment (9) a content delivery module (10) and content consolidation modules (11).

### DESCRIPTION OF FIGURES

Attached FIG. 1 is the schematic view of the system.

FIG. 2 is a flowchart of the system used in the invention and the present art.

FIG. 3 is a schematic view of the Partial Site Request Routing mechanism used in the present art.

FIG. 4 is a schematic view of the invention.

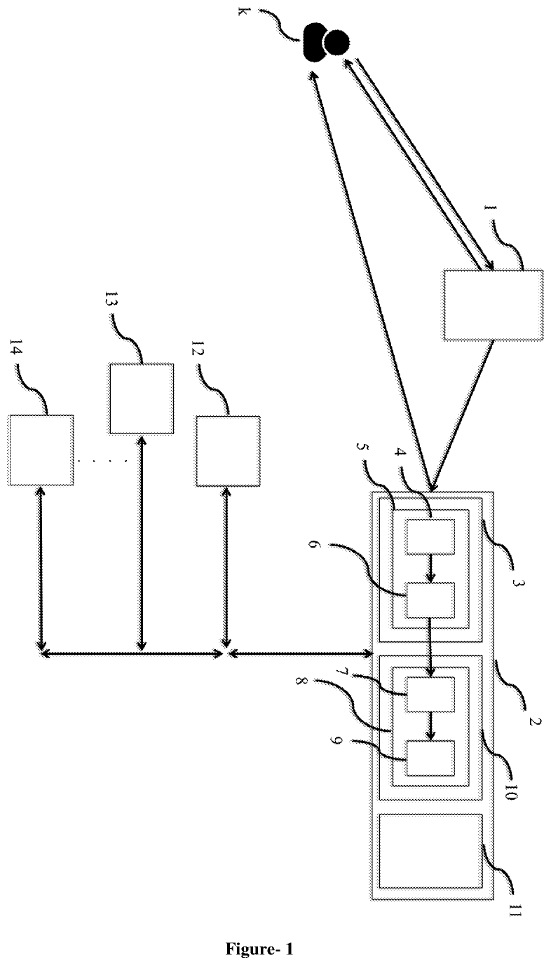

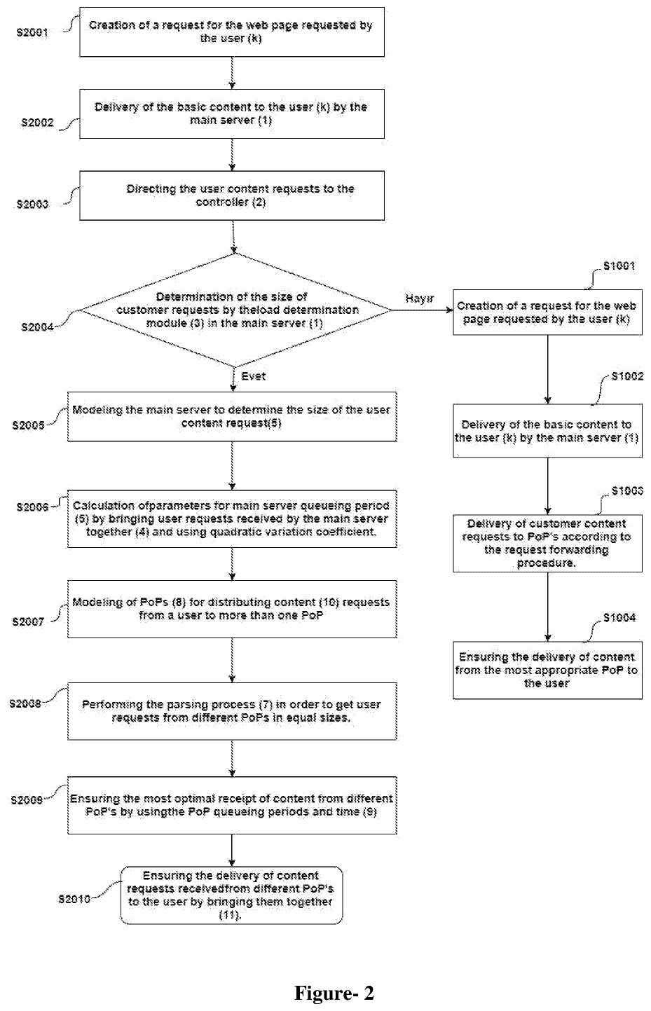

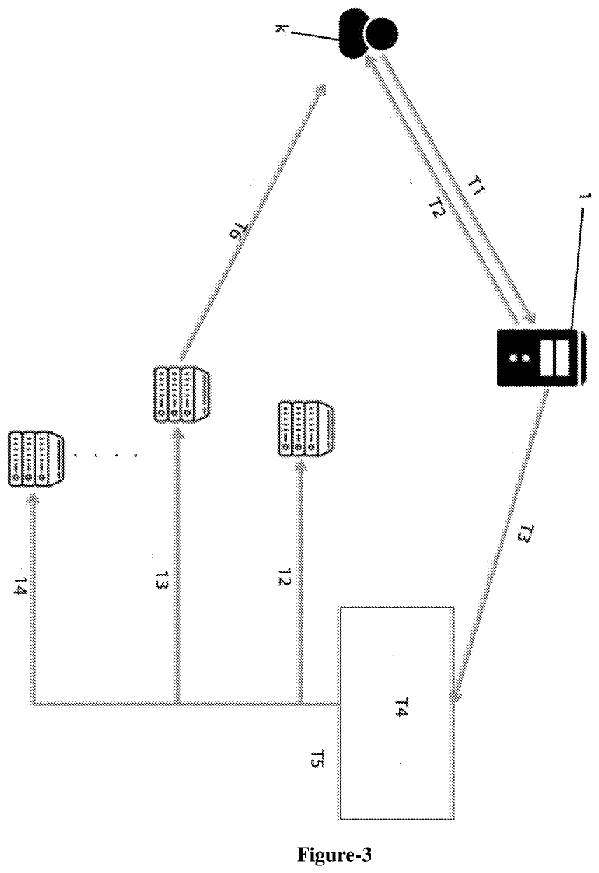

FIG. is a detailed schematic view of the invention.

Reference, letters and numbers representing the main process, expressions and elements in the figures are given below.
(1) Main server
(2) Controller
(3) Load Detection Module
(4) Mapping
(5) Main server modeling
(6) Queuing
(7) Parsing
(8) PoP modeling
(9) Adjustment
(10) Content delivery module
(11) Content consolidation module
(12) PoP-1
(13) PoP-2
(14) PoP-N
(k) User
(T1) User requests
(T2) Simple basic content
(T3) Request routing (for large size content)
(T4) CDN provider request routing algorithm
(T5) Request routing
(T6) Content is obtained from the nearest POP
(T7) Recommended request routing algorithm
(T8) All content
(T9) Request forwarding
(T10) All content received from k number of PoP.
(T11) Content part 1
(T12) Content part 2
(T13) Content part 3
(T14) Set parsing indices

### DETAILED EXPLANATION OF THE INVENTION

The invention provides an autonomous way of communicating transmitted user requests to multiple PoPs in contrast to the request routing procedure in content delivery networks, in order to access substantially larger content. Sudden and over loading of PoPs is prevented, thereby user losses and response times are reduced thanks to the invention.

A new method, which we call the parametric-parsing based on the examination of effect of user requests transmitted for accessing contents in large sizes on the request routing procedure in content delivery networks, is offered. Parametric-parsing provides an autonomous way to consolidate large size user requests in the main server (1) and again to transfer to the PoP. In this way, it is ensured that the user requests delivered are transferred to more than one PoP in order to access the contents of large sizes, there by the problem of sudden and excessive loading of a single PoP is avoided. At the same time, user losses and response times are reduced. Basically, the solutions provided by the invention are as follows;
The main server (1) and PoPs are modeled according to the G/G/1 system by using the queuing theory.
In the modeling of the main server (1), the load status is determined by defining two procedures as mapping (4) and queuing (6). This load condition is used for making parsing (7) of the content.
Two procedures are described as parsing (7) and adjustment (9) for modeling PoPs. With the parsing (7) procedure, the queueing load and waiting time parameters of the PoPs are transmitted to the adjustment (9) procedure. In the adjustment (9) procedure, parsed content sizes are determined by using the parsing (7) index parameter defined and queue loads and waiting period parameters of Pop's as obtained from the parsing (7) procedure are used for determining this index.

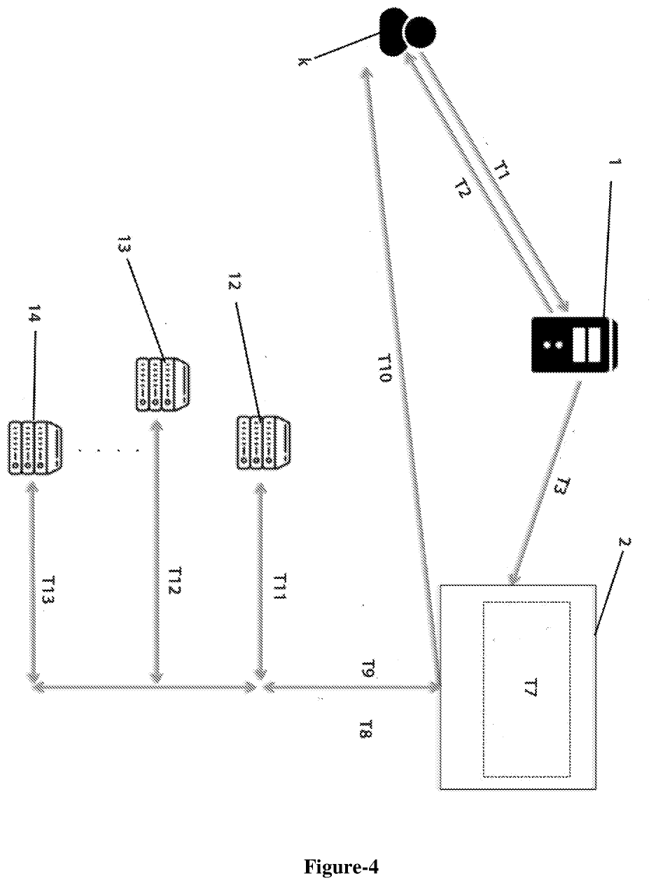

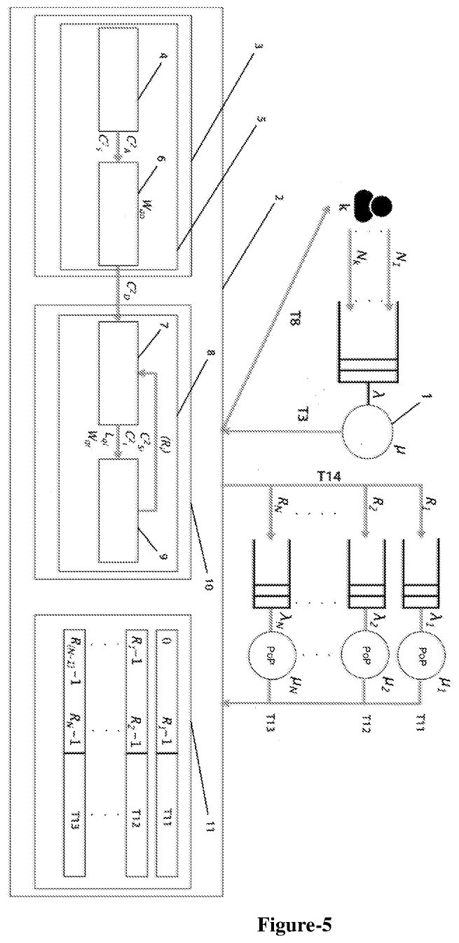

In the system subject to the invention, the requests created by users (k) to in the internet to access a website content are transferred to the main server (1) first. The main server (1) sends the content of the web page to the user and sends the user request to PoP (12) to receive more complex and large contents. However, if the transferred user request is forwarded to access large contents, this causes a sudden and excessive load of the specified PoP in normal system running in this way This also increases user losses and response times. In order to solve this problem, the present invention enables user requests to be redirected to more than one PoP instead of a single PoP, and to retrieve the content from these PoPs. In this way, a more optimal system is obtained by reducing user losses and response times. In the invention, the main server (1) sends user requests transmitted for large size contents to the controller (2). The controller (2) carries out the request routing method proposed in the invention. First, the load determination module (3) determines the load level in the main server (1). If the load level of the main server (1) is above a certain value, the request routing algorithm suggested in the invention, is activated. This amount of load is determined by the main server modeling (5) module by using the mapping (4) and queuing (6) procedures. The main server modeling (5) module uses the parameters on the time to reach of user requests to the server and the quadratic variation coefficient between these requests. Following these parameters, information about the load amount of the main server (1) is obtained. The user requests reach the main server (1) with a random characteristic instead of following a certain distribution pattern. Therefore, the main server (1) is modeled using the G/G/1 queue system. In the mapping (4) procedure, the requests transferred from the user to the main server (1) are combined and a total λ is calculated. After calculating this value, the coefficient of quadratic variation between the requests coming to the main server (1) is calculated. In addition, the coefficient of quadratic variation between the requests sent to the main server (1) is calculated. By using the queuing (6) procedure, the coefficient of quadratic variation between the requests transferred from the main server (1) and main server (1) queuing time are calculated. Using these two values, user requests sent to access the content in large sizes are determined and the method proposed in the invention is used. The controller (2) then decides parsing (7) index value through the PoP modelling through parsing (7) and adjustment (9) procedures in the content distribution module (10). Thereby it is ensured that the content is retrieved from different PoPs in the most appropriate way. For this purpose, the PoPs are modeled using the G/G/1 system and the Xi and pi values of the PoPs are obtained. The coefficient of quadratic variation between the user requests transferred to the PoPs is then calculated. In addition, queuing times and load quantities of PoPs are also calculated. The load and waiting time based parsing index (7) is calculated using these two values calculated for each PoP. First of all, the user requests received in equal sizes from all PoPs, are obtained from different PoPs in optimal sizes by using this calculated parameter. In this way, no PoP is overloaded and users' queuing times are reduced. The operating principle of the system described above is briefly shown in FIG. 4 and FIG. 5.

The main server (1) used in the invention is the server that keeps the originals of all contents and transmits them to the PoPs. The structure that performs all the proposed procedures and modules is the controller (2). The load determination module (3) determines the load of content requests coming to the main server (1). In this way, it decides whether incoming requests are sent to access large content. In this process, the main server uses the modeling (5) module together with the mapping (4) and queuing (6) procedures. The mapping (4) procedure allows content access requests from the users to be brought together mathematically in the main server (1). Queuing (6) procedure calculates the quadratic variation coefficient and main server (1) queueing periods in order to determine whether the requests coming to the main server (1) are for accessing large size contents. Main server modeling (5) allows the main server (1) to be modeled according to the G/G/1 system. It provides support to the mapping (4) and queuing (6) modules. Parsing procedure (7) ensures to get user requests from different PoPs in equal sizes primarily. PoP-1 (12), PoP-2 (13) and PoP-N (14), expressed in FIG. 4, are different PoPs located at different distances. Then adjustment (9) procedure is carried out for ensuring that the content is obtained from different PoP's in the most optimal way possible by using parsing (7) index parameter identified and queueing period and time of PoP's. PoP Modeling (8) enables the modeling of PoPs according to the G/G/1 system. It provides support for parsing (7) and adjustment (9) modules. The content distribution module (10) provides support to PoP modelling (8) for distributing the content requests from the users to more than one PoP's. The content consolidation module (11) allows bringing content requests received from different PoP's together and delivering them to the user. The mentioned PoPs are the servers that meet the content requests that are close to users.

Recommended Request Routing Model

As described above, the method of demand routing proposed by the invention is governed by the controller (2). This controller (2) consists of three basic modules which are the load detection module (3), the content delivery module (10) and the content consolidation module (11).

A. Load Detection Module

The controller (2) decides the suitability of using the proposed method by evaluating the amount of load on the main server (1). If the user has submitted a request to access large size content, the amount of load on the main server (1) exceeds a certain level and the request routing model proposed in the invention should be used. For this purpose, the load determination module (3) takes user requests from the main server (1) as input and gives the load amount of the main server (1) as output. The load detection module (3) supports the main server modeling (5) sub-module with the mapping (4) and queuing (6) procedures.

1. Main Server Modeling

The requests received during the modeling of the main server (1) are characterized using two parameters. Here, the first parameter λ is the average arrival rate of user requests to the main server (1), which can be expressed as 1/E[A]. In this expression, A indicates the arrival time of user requests to the main server (1), and E[A] is the expected value of this arrival time. The second parameter C_{A}² is the coefficient of quadratic variation between requests coming to the main server (1). λ and C_{A}² relate to the first and second moments of arrival times of user requests. Thus, by examining these two parameters, information about the arrival characteristics of the user requests can be obtained. For this purpose, the main server modeling (5) can be divided into two procedures as mapping (4) and queuing (6).

a. Mapping

User requests are not forwarded to the main server (1) in a certain pattern. These requests are transferred to the main server (1) in random distributions with high variability. The total number of user requests transmitted to the main server (1) is obtained by mapping (4) all requests. Where Nⱼ(t) is the number of requests transmitted from the user to the main server (1) at the time of t. The total arrival process N(t) transmitted to the main server (1) is obtained by taking the sum of all Nⱼ(t) values. As a result, the arrival rate of the user requests to the main server (1) is obtained as expressed in Equation-1.

$${λ}_{j} ≡ {lim}_{t -> ∞} \frac{E [ {N}_{j} ( t ) ]}{t} \qquad Equation \text{-} 1$$

Similarly, the total arrival rate λ is obtained by taking the sum of all arrival rates (λⱼ) and is equal to the value in Equation-2.

$${lim}_{t -> ∞} \frac{E [ N ( t ) ]}{t} \qquad Equation \text{-} 2$$

As the result, the coefficient of quadratic variation between the requests coming to the main server (1) is calculated as shown in Equation-3.

$${C}_{A}^{2} = \frac{1}{λ} {\sum }_{j = 1}^{k} {λ}_{j} {C}_{j}^{2} \qquad Equation \text{-} 3$$

In this equation, Cⱼ² is the coefficient of quadratic variation between requests transferred from the user to the main server. The service rate of the main server (1) is calculated by μ=1/E[S] equation. Here, S is the random service time of the main server (1) and E[S] is the expected value of this time.

b. Queuing

The user requests transmitted for accessing large size contents are transferred to PoPs. The coefficient of quadratic variation between the requests transferred from the main server (1) is calculated by using the formula given in Equation 4.

$${C}_{D}^{2} = {ρ}^{2} {C}_{S}^{2} + ( 1 - {ρ}^{2} ) {C}_{A}^{2} , ( ρ = \frac{λ}{μ} ) \qquad Equation \text{-} 4$$

Here, C_{S}² is the quadratic coefficient of variation of service distributions on the main server (1). C_{A}² and C_{S}² show the variability level of arrival and service distributions. In other words, high values in these parameters indicate that the requests coming to the main server (1) are large size requests. In addition, the queueing time of the main server (1) according to the G/G/1 model is calculated by the formula given in Equation-5.

$${W}_{{q}_{o}} = E ( S ) \frac{ρ}{1 - ρ} \frac{{C}_{A}^{2} + {C}_{S}^{2}}{2} , ( ρ = \frac{λ}{μ} ) \qquad Equation \text{-} 5$$

In addition to the variation coefficients, the higher queueing time also supports the information that the main server (1) occupancy is more than normal.

B. Content Delivery Module

The requests transferred from the main server (1) are firstly transferred to different PoPs in equal dimensions. Then, it is ensured that the content is obtained from different PoPs in the most optimal way possible by using queueing loads and queueing times of different PoPs by means of the parsing (7) index parameter defined. For this purpose, the PoP modeling (8) sub-module is supported parsing (7) and adjustment (9) procedures.

1. PoP modeling

G/G/1 queue system is used for modeling PoPs (8). The arrival and service rates of user requests to PoPs are λᵢ=1/E[Aᵢ] and μᵢ=1/E[Sᵢ] Here, Aᵢ ve Sᵢ show PoPs' request arrival and service times. Similarly, E[Aᵢ] and E[Sᵢ] are the expected values of these times.

a. Parsing

User requests that are sent to access large contents are met from different PoPs. The coefficient of quadratic variation between the user requests directed to the PoP is calculated as in Equation 6.

Cᵢ²=RᵢC_{D}²+(1−Rᵢ), ∀i=1, . . . ,N Equation-6

In this equation, C_{D}² is obtained from the queuing (6) procedure. In addition, the index of parsing (7) shown here with the R, symbol is defined. When defining this parameter, the queuing load and queue wait times of the PoPs are used. The queuing time of the PoPs according to the G/G/1 model is calculated by the formula expressed in Equation-7.

$${W}_{{q}_{i}} = E ( {S}_{i} ) \frac{{ρ}_{i}}{1 - {ρ}_{i}} \frac{{C}_{i}^{2} + {C}_{Si}^{2}}{2} , ( {ρ}_{i} = \frac{{λ}_{i}}{{μ}_{i}} ) \qquad Equation \text{-} 7$$

Similarly, queuing loads of PoPs are calculated by the formula given in Equation-8.

$${L}_{{q}_{i}} = \frac{{ρ}_{i}^{2}}{1 - {ρ}_{i}} \frac{{C}_{i}^{2} + {C}_{Si}^{2}}{2} , ( {ρ}_{i} = \frac{{λ}_{i}}{{μ}_{i}} ) \qquad Equation \text{-} 8$$

b. Adjustment

This procedure allows the content to be obtained optimally from PoPs and prevents excessive loading of any PoP. For this purpose, with the help of the quadratic variation coefficients, the queuing time and loads of the PoPs are calculated and the parsing (7) index is determined as given in Equation-9.

$${R}_{i} = \frac{\frac{{L}_{{q}_{i}} ( {C}_{i}^{2} , {C}_{Si}^{2} )}{{\sum }_{i = 1}^{N} {L}_{{q}_{i}} ( {C}_{i}^{2} , {C}_{Si}^{2} )} + \frac{{W}_{{q}_{i}} ( {C}_{i}^{2} , {C}_{Si}^{2} )}{{\sum }_{i = 1}^{N} {W}_{{q}_{i}} ( {C}_{i}^{2} , {C}_{Si}^{2} )}}{2} \qquad Equation \text{-} 9$$

In the numerator part of the equation, two different calculations are performed based on queue load and queue waiting time. Content is obtained from PoPs according to the index value obtained. The content parsing and content size adjustment operations are summarized in the algorithm given in the Algorithm-1.

Algorithm 1 - Content Parsing and
Content Size Adjustment
Algorithm

L_{T} = 0
W_{T} = 0
for i ← 1 to N do
Calculate Rᵢ = 1/N
end for
Queue Load Based Adjustment( )
for i ← 1 to N do
Calculate Cᵢ²
Calculate L_{qi}
Add L_{qi} to L_{T}
end for
Queue Waiting Time Based Adjustment( )
for i ← 1 to N do
Calculate Cᵢ²
Calculate W_{qi}
Add W_{qi} to W_{T}
end for
for i ← 1 to N do
Rᵢ = (L_{qi} +W_{qi})/2(L_{T} + W_{T})
Assign KRᵢ to surrogate i
end for

C. Content Consolidation Module

It is the module where the contents of different PoPs are merged in the controller before being transmitted to the user. A sort range was used at the package head in order to achieve this content consolidation. Using the values in this range, the controller (2) allows the consolidation of the packages appropriately without changing the contents. In other words, the controller (2) consolidates the packages received from the PoPs by using the specified range values and transfers them back to the user.

They system which basically provides an autonomous way of communicating transmitted user requests to multiple PoPs in contrast to the request routing procedure in content delivery networks, in order to access substantially larger content is composed of following steps:
Creation of a request for the web page requested by the user (k)(S2001),
Delivery of the content to the user (k) by the main server (1) (S2002),
Directing the user content requests to the controller (2) (S2003),
Determination of the size of customer requests by the load determination module (3) in the main server (1) (S2004),
Modeling the main server to determine the size of the user content request (5) (S2005),
Calculation of parameters for main server queueing period (5) through queueing (6) by bringing user requests received by the main server through mapping procedure (4) and using quadratic variation coefficient. (S2006),
Modeling of PoPs with PoP modelling (8) procedure for distributing content requests from a user to more than one PoP by using the delivery module (10) (S007),
Performing the parsing process (7) in order to get user requests from different PoPs in equal sizes (S2008),
Ensuring the most optimal receipt of content from different PoP's by using the PoP queueing periods and time (S2009),
Ensuring the delivery of content requests received from different PoP's to the user by bringing them together (S2010).

### MATHEMATICAL SYMBOL EXPLANATIONS

| | |
|---|---|
| λ, μ | Request arrival and service rates of the main server (1) |
| λᵢ, μᵢ | Request arrival and service rates of PoPs |
| Rᵢ | Parsing (7) index |
| C_{A}², C_{S}² | The quadratic coefficient of variation of arrival and service |
| | distributions on the main server (1). |
| C_{D}² | The coefficient of quadratic variation between requests |
| | transferred from the main server. |
| Cⱼ² | The coefficient of quadratic variation between the requests sent |
| | from the user to the main server (1). |
| Cᵢ²,C_{Si}² | Coefficient of coefficient variation between requests and server |
| | distributions transferred to PoPs. |
| G/G/1 | The queue model system with a single server, |
| | where the reception |
| | and servicing times of the requests are generally distributed. |
| A | Arrival time for user requests to the main server (1) |
| E[A] | Expected arrival time for user requests to the main server (1) |
| Nⱼ(t) | number of requests transmitted from the user to the main server |
| | (1) at the time of t. |
| N(t) | The total arrival process transmitted to the main server (1) |
| λⱼ | Arrival ratio for user requests to the main server (1) |
| E[Nⱼ(t)] | expected value of requests transmitted from the user to the main |
| | server (1) at the time of t. |
| S | The random service time of the mmain server (1) |
| E[S] | Expected value of random service time of the main server (1) |
| W_{qo} | Main server (1) queueing time |
| Aᵢ | Request arrival times of PoPs |
| Sᵢ | Service times of PoPs |
| E[Aᵢ] | Expected value of request arrival times of PoPs |
| E[Sᵢ] | Expected value of service times of PoPs |
| W_{qi} | Queuing times of PoPs, |
| L_{qi} | Queuing loads of PoPs, |
| ρ | Utilization rate |

1. A system that enables CDN (Content Delivery Networks) companies to provide higher quality service by minimizing user delays and losses during demand routing procedures comprising the following steps:
creation of a request for the web page requested by a user,
delivery of a content to the user by a main server,
directing user content requests to a controller,
determination of the size of customer requests by a load determination module in a main server,
modeling the main server to determine the size of the user content request,
calculation of parameters for main server queueing period through queueing by bringing user requests received by the main server through mapping procedure and using quadratic variation coefficient,
modeling of PoPs with PoP modelling procedure for distributing content requests from the user to more than one PoP by using the delivery module,
performing a parsing process in order to get user requests from different PoPs in equal sizes,
ensuring the most optimal receipt of content from different PoP's by using the PoP queueing periods and time, and
ensuring the delivery of content requests received from different PoP's to the user by bringing them together.

2. The system of claim 1, wherein the system contains the following process steps: the algorithm which is activated when the load level of the main server is above a certain value,
it the system determines the parsing index value through the PoP parsing through modelling and adjustment procedures in the content distribution module, thereby ensuring that the content is retrieved from the most appropriate PoP,
modeling of PoPs by using G/G/I system and obtaining lï and pi values,
calculation of quadratic coefficient of variation between user requests transferred to PoPs,
calculation of queuing time and load quantities of PoPs,
calculation the load and waiting time based parsing index using these two values calculated for each PoP,
obtaining from different PoPs in optimal sizes by using this calculated parameter, and
reducing the queueing periods of the users.

3. The system of claim 1, wherein the system has a controller that determines the parsing index value through the PoP parsing through modelling and adjustment procedures in the content distribution module.

4. The system of claim 1, wherein the system has a load determination module that determines the load of content requests to the main server and decides whether incoming requests are sent to access large contents.

5. The system of claim 1, wherein the system has a mapping procedure that allows content access requests from the users to be brought together mathematically in the main server.

6. The system of claim 1, wherein the system has a main server modeling procedure, which provides a support for the mapping and queuing modules, allowing the model to be modeled on a queue model system with a single server, where the reception and servicing times of the requests are generally distributed.

7. The system of claim 1, wherein the system has a queuing procedure that calculates the quadratic variation coefficient and main server queueing periods in order to determine whether the requests coming to the main server are for accessing large size contents.

8. The system of claim 1, wherein the system has a parsing procedure in order to get user requests from different PoPs in equal sizes primarily.

9. The system of claim 1, wherein the system has a PoP modeling procedure that ensures modelling of PoP's according to the G/G/I system and supports the parsing and adjustment modules.

10. The system of claim 1, wherein the system has an adjustment procedure for ensuring that the content is obtained from different PoP's in the most optimal way possible by using parsing index parameter identified and queueing period and time of PoP's.

11. The system of claim 1, wherein the system has a content distribution module that supports PoP modelling for distributing the content requests from the users to more than one PoP's.

12. The system of claim 1, wherein the system has a content consolidation module that allow bringing content requests received from different PoP's together and delivering them to the user.
